(19) United States
(12) Patent Application Publication
(10) Pub. No.: US 2026/0254249 A1
(43) Pub. Date: Aug. 27, 2026

(54) HYBRID POWER GENERATING AND CHILLING-REFRIGERATION SYSTEM

(71) Applicant: MayMaan Research, Inc., Hollywood, FL (US)

(72) Inventors: Eitan Shmueli, Hollywood, FL (US); Doron Shmueli, Hollywood, FL (US); Yehuda Shmueli, Hollywood, FL (US)

(73) Assignee: MayMaan Research, Inc., Hollywood, FL (US)

(21) Appl. No.: 19/546,758

(22) Filed: Feb. 23, 2026

Related U.S. Application Data
(60) Provisional application No. 63/762,362, filed on Feb. 24, 2025.

(51) Int. Cl. H02J 3/32; G05B 19/042; H02J 3/38; H02J 7/14; H02J 7/90

(52) U.S. Cl. CPC H02J 3/32; G05B 19/0426; H02J 3/38; H02J 7/14; H02J 7/933; H02J 7/977; G05B 2219/2654

(57) ABSTRACT

A hybrid power generating and chilling/refrigeration system may include an engine, a motor having a motor shaft, a compressor mechanically coupled to the motor, a clutch, a processing device communicatively coupled to the engine, the motor, and the clutch, and a processing device. The processing device is configured to when in the presence of the external electricity, initiate a grid-powered mode configured to actuate the clutch into the disengaged state and drive the compressor using the external electricity to the motor, and when in the absence of the external electricity, initiate an engine-driven mode configured to start the engine, actuate the clutch into the engage stated, and drive the compressor via a mechanical torque output from the engine onto the motor shaft, wherein the system is configured to selectively alternate between the grid-powered mode and the engine-driven mode without converting engine shaft power to grid-frequency electricity to operate the compressor.

### CROSS REFERENCE TO RELATED APPLICATIONS

This utility patent application claims priority benefit from U.S. Provisional Patent Application Ser. No. 63/762,362, filed Feb. 24, 2025, and entitled “Hybrid Power Generating and Chilling-Refrigeration System”, the entire contents of which is incorporated by reference herein in its entirety.

### TECHNICAL FIELD

The present disclosure relates to hybrid power generation and cooling/refrigeration systems and more particularly to hybrid power generation and cooling/refrigeration systems configured to combine an internal combustion engine and a motor to drive a refrigeration compressor and supply electrical power in backup or off-grid conditions.

### BACKGROUND

Air conditioning and chillers have been used for many years for a variety of applications such as in commercial, industrial, and mission-critical applications. These systems typically employ electrically driven compressors, which account for a majority of system energy consumption. Backup and off-grid systems further introduce inefficiencies by converting mechanical energy from an engine to electrical energy and then reconverting that electrical energy back into mechanical energy to drive a compressor.

These multiple energy conversion stages result in significant losses and constrain engine operation to fixed rotational speeds dictated by electrical frequency requirements. As a result, engines are frequently operated outside their optimal efficiency ranges, leading to reduced overall system efficiency, increased fuel consumption, and higher emissions.

Accordingly, there exists a need for an improved system that reduces unnecessary energy conversions, allows engines and compressors to operate within preferred efficiency ranges, and provides reliable chilling and power generation capability under varying operating conditions.

### SUMMARY

In one embodiment, a hybrid power generating and chilling/refrigeration system may include an engine, a motor having a motor shaft, a compressor mechanically coupled to the motor, a clutch configured to be actuatable between a disengaged state and an engaged state to selectively couple torque from the engine to the motor shaft, a processing device communicatively coupled to the engine, the motor, and the clutch, and a non-transitory, processor-readable storage medium in communication with the processing device. The non-transitory, processor-readable storage medium comprising one or more programming instructions that, when executed, cause the processing device to receive an input regarding a presence or an absence of an external electricity, when in the presence of the external electricity, initiate a grid-powered mode configured to actuate the clutch into the disengaged state and drive the compressor using the external electricity to the motor, and when in the absence of the external electricity, initiate an engine-driven mode configured to start the engine, actuate the clutch into the engage stated, and drive the compressor via a mechanical torque output from the engine onto the motor shaft, wherein the system is configured to selectively alternate between the grid-powered mode and the engine-driven mode without converting engine shaft power to grid-frequency electricity to operate the compressor.

In another embodiment, a method for operating a hybrid power generating and chilling/refrigeration system may include monitoring an availability of an external electricity, when the external electricity is present, actuating a clutch into a disengaged state, and energizing a motor via the external electricity to drive a compressor, and upon loss of the external electricity, actuating the clutch into an engaged state and initiating the engine into an on mode to output a torque, and driving the compressor via the motor through a motor shaft.

In yet another embodiment, a hybrid power generating and chilling/refrigeration system may include an internal combustion engine, a motor having a motor shaft, a compressor mechanically coupled to the motor, and a clutch configured to be actuatable between a disengaged state and an engaged state to selectively couple torque from the engine to the motor shaft. The system may further include a processing device communicatively coupled to the engine, the motor, and the clutch and a non-transitory, processor-readable storage medium in communication with the processing device. The non-transitory, processor-readable storage medium comprising one or more programming instructions that, when executed, cause the processing device to receive an input regarding a presence or an absence of an external electricity, when in the presence of the external electricity, initiate a grid-powered mode configured to actuate the clutch into the disengaged state and drive the compressor using the external electricity to power the motor, when in the absence of the external electricity, initiate an engine-driven mode configured to start the internal combustion engine, actuate the clutch into the engaged state, and drive the compressor via a mechanical torque output from the internal combustion engine onto the motor shaft, and adjust an operating speed of the engine to correspond to an efficiency range of the engine prestored in the processor-readable storage medium. The system is configured to selectively alternate between the grid-powered mode and the engine-driven mode without converting engine shaft power to grid-frequency electricity to operate the compressor, and the motor is configured to operate powered from the external electricity and mechanically through the engine and the motor shaft, and is configured to operate in a generator/alternator mode to generate a second electrical power.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematic depicts an example system architecture with the system in an engine-engaged, mechanically driven cooling mode, according to one or more embodiments shown and described herein;

FIG. 2 schematic depicts the example system architecture of FIG. 1 with the system in a grid-powered cooling mode with the engine disengaged according to one or more embodiments shown and described herein;

FIG. 3 schematic depicts the example system architecture of FIG. 1 with a motor of the system in a generator/alternator mode charging a battery pack assembly according to one or more embodiments shown and described herein;

FIG. 4 schematic depicts the example system architecture of FIG. 1 including a secondary clutch according to one or more embodiments shown and described herein;

FIG. 5 schematically depicts a block diagram of illustrative components of a controller of the example systems of FIGS. 1-4 communicatively coupled together according to one or more embodiments shown or described herein;

FIG. 6 depicts a flow diagram of an illustrative method of switching between the grid-powered mode and the engine-powered mode of FIGS. 1 and 2, respectively, according to one or more embodiments shown and described herein; and

FIG. 7 depicts a flow diagram of an illustrative method of switching the motor of the systems depicted in FIGS. 1 and 2 into a generator/alternator mode according to one or more embodiments shown and described herein.

### DETAILED DESCRIPTION

Embodiments herein are directed to a hybrid power generating and chilling/refrigeration system that includes an internal combustion engine, a motor that is mechanically coupled to a motor shaft, a compressor that is mechanically coupled to the motor, a clutch that is disposed to selectively couple torque from the engine to the motor shaft, and an electronic control unit communicatively coupled to the engine, the motor, and the clutch. The electronic control unit is configured to switch the hybrid power generating and chilling/refrigeration system between an engine-engaged, mechanically driven cooling mode and a grid-powered cooling mode with the engine disengaged. The electronic control unit is configured to, when there is a presence of the external electricity, maintain the clutch disengaged and drive the compressor using the motor such that the external electricity drives the compressor. When there is a loss of the external electricity, the electronic control unit is configured to start the engine, engage the clutch, and drive the compressor via the engine and the motor shaft. As such, the hybrid power generating and chilling/refrigeration system described herein is configured such that the system selectively alternates between the grid-powered mode and the engine-driven mode without converting engine shaft power to grid-frequency electricity to operate the compressor.

The hybrid power generating and chilling/refrigeration system provides several improvements over conventional systems. For example, while conventional systems generally includes a compressor and blower condenser, the compressor is driven by a motor, which results in a large portion of the overall energy consumption of the systems. In advanced conventional systems, the motor is a variable speed (e.g., an inverter system). In these conventional systems, a basic breakdown of the overall energy consumption by component may include the compressor consuming 60%-85% of the overall energy consumption, an indoor blower fan consuming 10%-15% of the overall energy consumption, an outdoor condenser fan consuming 5%-10% of the overall energy consumption and the control systems/electronics consuming <5% of the overall energy consumption.

The conventional compressor efficiency can be improved with a variable speed. In most cases such units are energized by a three-phase power input at 50 or 60 Hz, and a wide range of voltages. Many of the units are used in a commercial applications including large and small businesses and a variety of applications. In some cases, the need of such system to work with minimum to zero downtime, such as in crucial applications e.g., refrigeration systems for food conservation, hospitals, data centers, and the like. In such applications, various types of solutions are implemented to ensure the system stays functioning, such as backup generators, batteries, hydrogen fuel cell units, and/or the like, where most of the energy used is to turn the compressor.

In older data centers, the air conditioning systems are configured to cool the ambient air utilizing a regular air conditioning unit. In advanced data centers, there are central processing units (CPU)/graphic processing unit (GPU) level cooling system using water circulation. The system desired temperature is controlled by a thermostat, and may be turning the system on or off based on overall average desired temp target.

In backup or off grid systems where a generator is using a kinetic power of an engine to turn an alternator, then such electricity-usually three phase, has a conversion efficiency of converting from a kinetic (rotating energy) to eclectic energy is below 90%. Furthermore, the engines that are used are generally running at 1500 rpm to 1800 rpm for 50 Hz or 60 Hz output, as an engine output, determined by a function of torque and speed. It is known that limiting the speed results in a lower potential power output of the engine. In addition, an engine peak efficiency is usually outside of the range of 1500 rpm-1800 rpm resulting in a low overall efficiency, and thus a low power output and lower power potential per engine displacement as a power output is a function of torque and RPM speed e.g., Horsepower=(Torque×RPM)/5252.

Once the electricity is delivered to the motor that runs the compressor, turning electrical energy back to rotating kinetic energy where the efficiency of that conversion is described below with or without an inverter. The general efficiency of an inverter-driven motor in a standard three-phase induction motor is 85%-95% efficient and a premium efficiency motor (IE3, IE4) is 95%-98% efficient. In modern variable frequency drives (VFD), the efficiency is generally 95%-98% efficient at full load. However, the efficiency decreases at low speeds due to harmonic losses and heat generation.

Further, it is known to calculate an overall system efficiency based on the following equation 1:

$$Total system efficiency = Motor Efficiency \times VFD Efficiency \qquad Equation 1$$

In a non-limiting example for driving the compressor from a motor, when the motor Efficiency is <95% and the VFD Efficiency is <97%, the total system efficiency: 0.95×0.97=92.15%. As such, the energy produced by the engines are going through two conversions-kinetic to electric, and electric back to kinetic. This process waste more than 18% of the energy. For example, using the same total system efficiency in equation 1, when the generator alternator efficiency is 90% and the motor/VFD efficiency is 92%, the total system efficiency of converting rotating kinetic energy to electricity and back to rotating kinetic energy is 82.8% plus additional parasitic loses as wires, switches, and the like.

The embodiments of the hybrid power generating and chilling/refrigeration system described herein provide for systems that integrate mechanical drive and electrical power functionality in a single package improving total system efficiency in air conditioning systems compared to conventional systems.

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

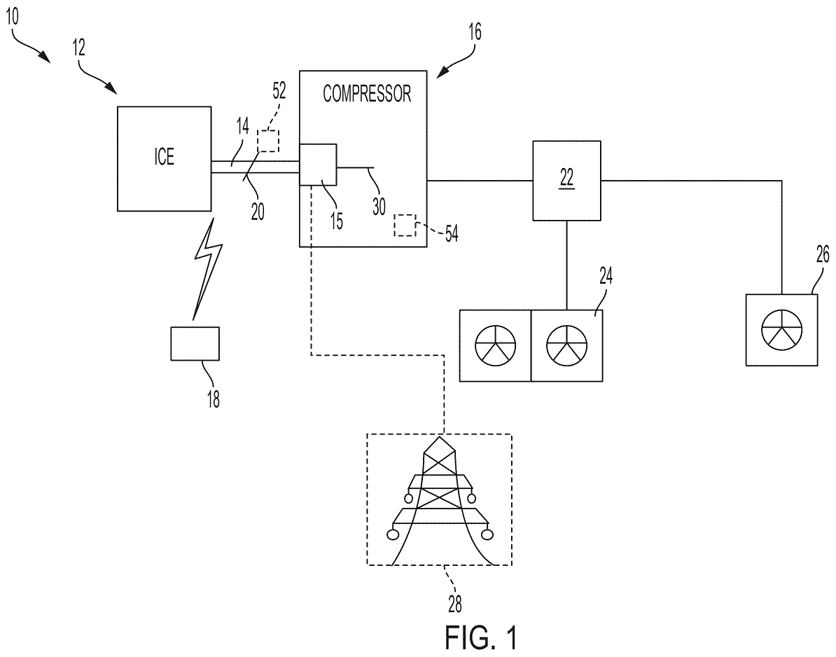

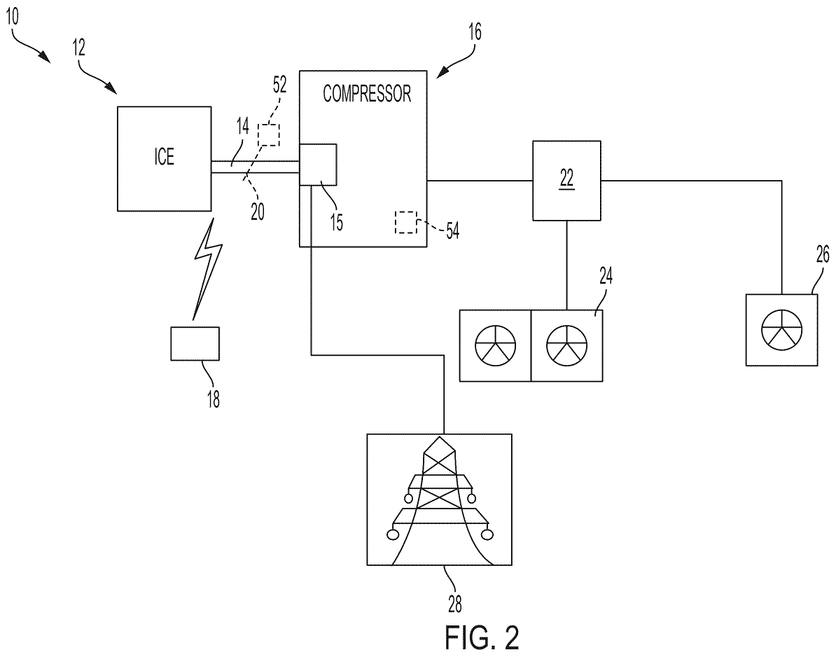

Referring now to FIGS. 1-2, an example hybrid power generating and chilling/refrigeration system 10 (hereinafter “system 10”) is configured to integrate mechanical drive and electrical power functionality in a single package. The system 10 includes an internal combustion engine (“engine”) 12 mechanically coupled in series to a motor 15 via a motor shaft 14 (e.g., drive shaft) mechanically coupled to the motor 15, which in turn drives a refrigeration compressor 16. A controller 18 is communicatively coupled to the engine 12 and the motor 15 to govern the engine 12 operation and the motor 15 operation and to coordinate associated HVAC components, such as, without limitation, condensers 22, an indoor blower fan 24, and an outdoor condenser fan 26. A selectively actuatable clutch 20, which may be a mechanical coupling, is disposed along the drive path to permit engagement or disengagement of engine 12 relative to motor 15. The actuatable clutch 20 is selectable between an engaged state, where the actuatable clutch mechanically couples the engine 12 to the motor shaft 14 such that the engine 12 is configured to provide torque through the motor shaft 14, back-driving the motor 15 and turning the compressor 16.

The engine 12 may be configured to act as or function as a primary mechanical power source for the system 10 during loss of external electricity 28. That is, the system 10 may be selectable operated between an engine-driven mode, as best illustrated in FIG. 1, and a grid-powered mode, as best illustrated in FIG. 2, to turn the compressor 16 based on whether there is an external electricity 28 provided to the system 10, as discussed in greater detail herein.

In embodiments, the engine 12 may be a conventional spark-ignition or compression-ignition engine, or a non-petroleum engine designed to operate on a water-dominant mixture containing 10-40% water-soluble flammable substances such as alcohols, acetone, or aldehydes. As such, the engine 12 may be any engine that includes a cylinder with a combustion chamber having a variable volume as defined by a reciprocating piston in a generally conventional manner. That is, the engine 12 may be any internal combustion variety and which can operate off of any fuel source not limited to various grades of gas, diesel, natural gas, propane, hydrogen, water, electric, and/or the like. Said another way, any engine type or any suitable engine that will make a kinetic power may be used herein. The engine 12 may be configured to selectable switch between an on mode, where the engine 12 is operable to provide the kinetic power, and an off mode, where the engine is not operating to provide the kinetic power.

Additionally, in a non-limiting example, as discussed above, the engine 12 may be a type of engine that limits the use of fossil fuels. For example, and without limitation, in this embodiment, hydrogen and air may be initially fed into the combustion chamber. Then, a fuel in the form of fine droplets of liquid is injected into the compressed combustion chamber. The resulting liquid/gas mixture is then compressed to a very high pressure, which causes the temperature to rise, and an ignition device that initiate the combustion. The combustion results in hot and pressurized gases that cause the piston to move and generate power. Advantageously, the fuel consists essentially of water and a flammable substance. The flammable material is an alcohol, acetone, aldehyde or other flammable, preferably non-fossil substance that is soluble in water (the term non-fossil is used to refer to a fuel that is not derived substantially from fossil-base, nonrenewable materials, such oil or natural gas, but from a renewable source). The fuel contains approximately 10-40% flammable material by volume.

As such, in this embodiment, the engine 12 may be adapted to power or drive the motor 15 via the motor shaft 14 based on (1) mixing hydrogen and air with a solution of water and a flammable, water soluble fuel (2) compressing the mixture to a high pressure to create high heat and a very explosive mixture in a combustion chamber, and (3) igniting the explosive mixture to cause the sudden expansion of such gases and the formation of steam thereby generating mechanical power.

The engine 12 may be further configured to incorporate, without limitation, a variable intake geometry, enabling optimized mixing of hydrogen, air, and injected water-fuel mixtures, enhanced cooling jackets sized for continuous operation in generator and cooling environments, reinforced crankshaft and flywheel mass to maintain rotational stability during transitions between grid-powered and engine-powered modes, and/or high-efficiency governor control allowing broad-range revolutions-per-minute RPM modulation independent of grid frequency constraints (unlike fixed-speed gensets). In hydrogen/water-based embodiments, the engine 12 may be configured to include a dual-injection system such as, without limitation, a hydrogen-air intake feed, and a direct injector delivering the water-fuel mixture into the compressed charge. It should be appreciated that this arrangement permits for a stratified, highly reactive mixture that ignites upon high compression, generating both combustion and steam expansion for enhanced torque output.

The motor shaft 14 may be configured as a through-shaft, mechanically coupling the engine 12 to the motor 15 and the motor 15 to the compressor 16. Such an arrangement differs from conventional HVAC systems where the motor drives the compressor only electrically, not mechanically. The motor shaft 14 may include, without limitation, torsional vibration dampers and spline or keyed interfaces for connection to and compatibility with the actuatable clutch 20. The motor shaft 14 may be formed from, without limitation, a high-strength alloy metal material.

The motor 15 may be a machine configured to convert electrical energy into mechanical energy and may be any types, including AC and DC motors. The motor 15 may include a high-temperature winding insulation, in case the motor 15 experiences any elevated temperatures when back-driven by the engine 12. The motor 15 may also be configured for a low cogging torque configuration for smoother transitions during the actuatable clutch 20 engagement. The motor 15 may be an electric motor.

The compressor 16 may be, without limitation, scroll, screw, rotary, or reciprocating type depending on system size. Further, the compressor 16 is configured to be driven or actuated either electrically (e.g., in the grid-powered mode), or mechanically (e.g., in the engine-powered mode), without the need for motor inversion hardware. The compressor 16 may be configured to include features such as, without limitation, a variable-speed capability enabled by an inverter 54 of the motor 15 when external electricity 28 is available and/or a direct-drive compatibility to enable the compressor 16 to rotate efficiently at engine-dictated speeds. As such, the compressor 16, in some embodiments, may be selected to operate over a wide speed range, enabling both high-load cooling and reduced-capacity standby cooling. In other embodiments, the compressor need not include these features and may be any conventional compressor in use today, on the market, and/or in the future.

The actuatable clutch 20 may be configured to provide the main mechanical engagement point between the engine 12 and the motor 15. The actuatable clutch 20 is configured to provide an automatic engagement during power loss (e.g., no presence or absence of external electricity 28 to switch the system 10 into the engine driven mode depicted in FIG. 1), immediate disengagement when grid power is restored (e.g., presence of the external electricity 28 to switch the system into the grid-powered mode depicted in FIG. 2) and a bumpless transfer between modes ensuring no torque spikes reach a compressor rotor of the compressor 16 and/or motor windings of the motor 15. In some embodiments, the actuatable clutch 20 may be electromagnetic and communicatively coupled to the controller 18 for control. This is non-limiting, and the actuatable clutch 20 may be any type of clutch, for example, and without limitation, hydraulically actuated, centrifugal-assist hybrid, and/or the like.

Further, the actuatable clutch 20 may include at least one sensor 52 that is communicatively coupled to the controller 18. In some embodiments, the at least one sensor 52 may be integrated into the actuatable clutch 20. In other embodiments, the at least one sensor 52 may be coupled to the actuatable clutch 20 via a fastener. Example fasteners include, without limitation, weld, adhesive, epoxy, screw, rivet, bolt and nut, hook and loop, and/or the like. The at least one sensor 52 may be configured for slip detection, temperature monitoring, and engagement force calibration. Additionally, or in the alterative, the at least one sensor 52 may include one or more sensors that may be configured to detect or sense temperature, pressure, position, speed, airflow, and exhaust composition of the engine 12, to optimize performance, fuel efficiency, and emissions, as well as temperature, vibration, speed, position, and electrical load in the motor 15 to prevent failures and optimize performance, and/or air/refrigerant pressure (suction/discharge), temperature, vibration levels to indicate mechanical wear, oil levels/quality, and flow rates of the compressor 16, as appreciated by those with skill in the art.

As best illustrated in FIG. 1, the engaged state of the actuatable clutch 20 permits for the engine 12 to drive the motor shaft 14 thereby operating the motor 15 to operate the compressor 16. Conversely, in the disengaged state of the actuatable clutch 20, as best illustrated in FIG. 2, disengages the engine 12 from the motor shaft 14 and the motor 15. As such, the engine 12 is not driving or providing torque to the motor shaft 14. As such, when the actuatable clutch 20 is in the disengaged state, the external electricity 28 will drive the motor 15 to operate the compressor 16.

As such, when there is a grid power to provide the external electricity 28 (e.g., the external electricity 28 is active), the engine 12 will be in the off mode (e.g., not operational and therefore in the disengaged state), and the external electricity 28 will turn the motor 15, which then drives or runs the compressor 16, as best illustrated in FIG. 2. In a loss of power situation (e.g., the external electricity 28 is inactive), the engine 12 will be operational (e.g., the on state), the actuatable clutch 20 is in the engaged state (e.g., mechanically coupling the motor shaft 14 to the engine 12) and engages with the motor 15 via the motor shaft 14 to provide torque to operate or turn both the motor 15 and thus the compressor 16, as best illustrated in FIG. 1.

It should be understood that in this configuration, the engine 12 will now generate torque to be used by the other components of the system 10, such as, without limitation, the condensers 22, the indoor blowing fans 24 or water pumps, the outdoor condenser fan 26, and the like. As a result of a direct coupling, there will be no efficiency losses. That is, all of the torque generated from the engine 12 will be converted into electrical power to rotate the compressor 16 thereby providing the necessary energy to all of the other components of the system 10. Furthermore, the engine 12 and/or the compressor 16 will be able to run in their respected efficiency ranges depending on the desired cooling target by ensuring that they are running at the proper RPM to reach maximum efficiency. That is, the arrangement of the system 10 permits for the engine speed of the engine 12 to be adjusted by the controller 18 to an efficiency operating point, which may be based on an efficiency map to operate the compressor within a predetermined efficiency band based on sensed data, a cooling setpoint, and/or the like, as discussed in greater detail herein.

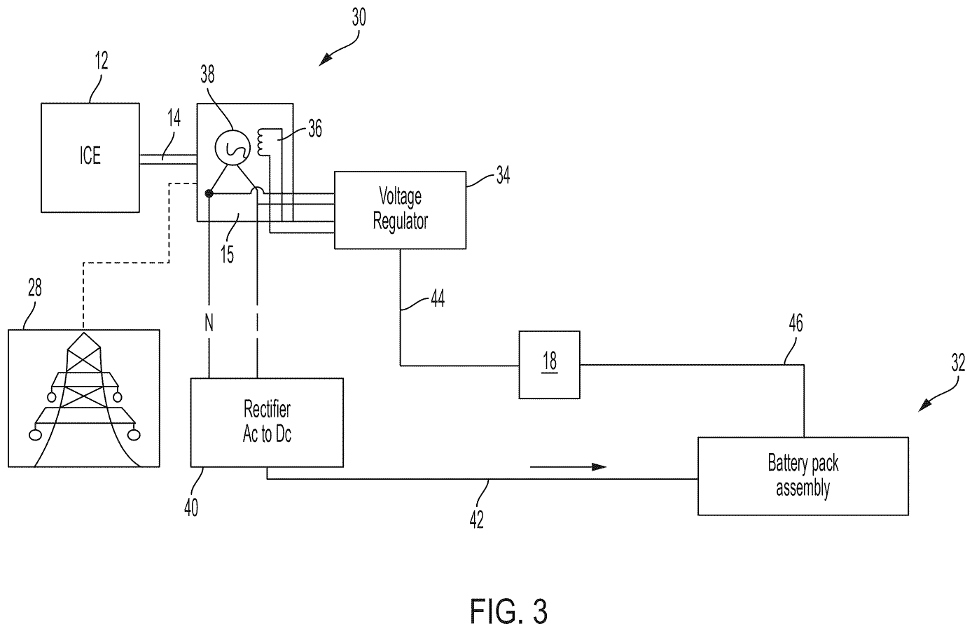

Referring to FIG. 3, a clutch system 49 includes the actuatable clutch 20 as the primary clutch and optionally, a secondary clutch 50 that acts as a second selectable mechanical coupling that is actuatable between a second engaged state and a second disengaged state. The secondary clutch 50 may be positioned between the motor 15 and compressor 16. As such, the secondary clutch 50 allows for motor 15 to run in the generator/alternator mode to generate electrical power to other components of the system 10 even when cooling demand is zero, as discussed in greater detail herein. The secondary clutch 50 may be configured to prevent unnecessary compressor cycling of the compressor 16 and enables the system 10 to act as a stand-alone power generator and battery charger.

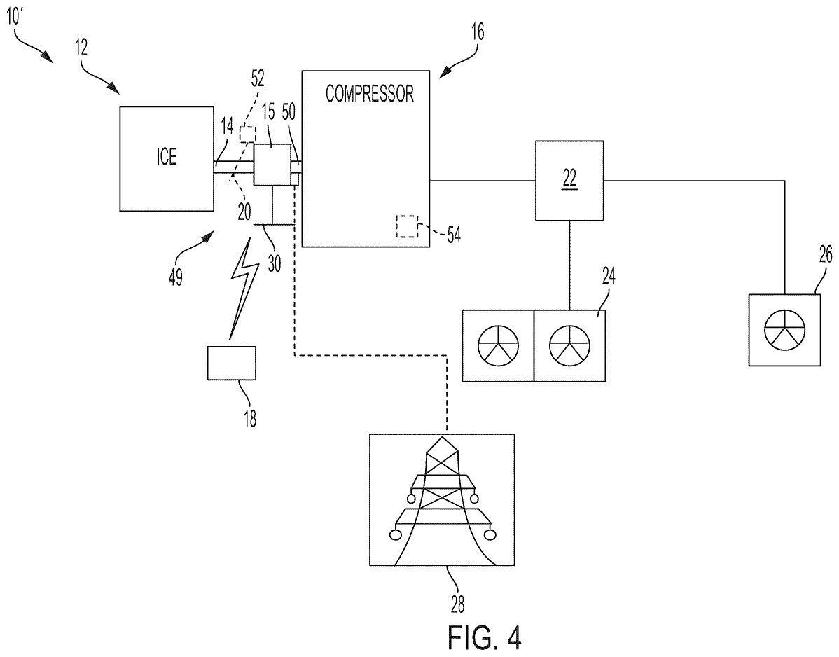

It should be understood that the system 10 may be modular and also provide additional auxiliary power from the motor 15. That is, the motor 15 may be configured to operate in an generator/alternator mode 30, as depicted in FIGS. 3-4. In the generator/alternator mode 30, the motor 15 may be configured to provide auxiliary power to the rest of the facility, such as to a battery pack assembly 32 (e.g., a plurality of DC battery cells formed from any known materials) for use by the system 10 and/or components external to the system 10.

As such, the motor 15 may be configured to have a dual functionality-as a prime mover for the compressor 16 in the grid-powered mode (FIG. 2) or the engine driven mode (FIG. 1) and as a generator/alternator in the generator/alternator mode 30, depicted best in FIG. 3. The motor 15 may include a stator field 36 and rotor field 38 that are configured to maximize AC output amplitude during the generator/alternator mode 30, as discussed in greater detail herein.

For example, when the motor 15 is in the generator/alternator mode 30, the motor 15 is configured to be an electrical generator that converts mechanical energy to electrical in the form of alternating current. The motor 15 is communicatively coupled to a voltage regulator 34 and operates to rectify an AC load to a DC voltage output prior to being delivered to the battery pack assembly 32. This may occur, when using as an alternator, through each of a stator field 36 and rotor field 38 represented within the motor 15 which interfaces with the voltage regulator 34 and operates to supply the AC output to a rectifier component 40 for conversion to DC, which is then transmitted via a output line 42 to the battery pack assembly 32. As such, it should be appreciated that the rectifier component 40 is communicatively coupled to the battery pack assembly 32 via the output line 42. Without limitation, the motor 15 when in the generator/alternator mode 30 outputs an AC load produced that is converted the rectifier component 40 and the voltage regulator 34 without the need for an external charging station to charge the batteries of the battery pack assembly 32. As such, the arrangement of the novel hybrid power generating and chilling/refrigeration system 10 provides a direct DC charging to the battery pack assembly 32.

The communication line 44 may be communicatively coupled to and extending between the controller 18 and the voltage regulator 34, which is a configured as a device, used in generators to automatically regulate a voltage level by smoothing out any fluctuations in voltage into a constant level. That is, the voltage regulator 34 may filter or smooth the sine/cosine waves into a repeatedly constant level. As such, the voltage regulator 34 may be configured to smooth AC waveforms, maintain constant DC voltage, preventing overcharge or undercharge, and/or actively modulate field excitation in the motor 15 when used as an alternator. Further, the rectifier component 40 may be configured as a high amperage diode bridge or MOSFET synchronous rectifier that is configured to lower heat generation, provide charging efficiency compared to conventional systems, and/or provide bidirectional current sensing.

The communication line 44 permits the voltage regulator 34 to adjust the voltage to in turn determine the rate of charge based on specifications of the battery pack assembly 32. Further, the engine 12 and/or the motor 15 may each be adjusted by the controller 18, such as adjusting at least one of engine speed of the engine 12 or a generator speed of the motor 15 to an efficiency operating point based on sensed data, such as, without limitation a battery temperature, a charging current or output, and a state of charge of the battery pack assembly 32.

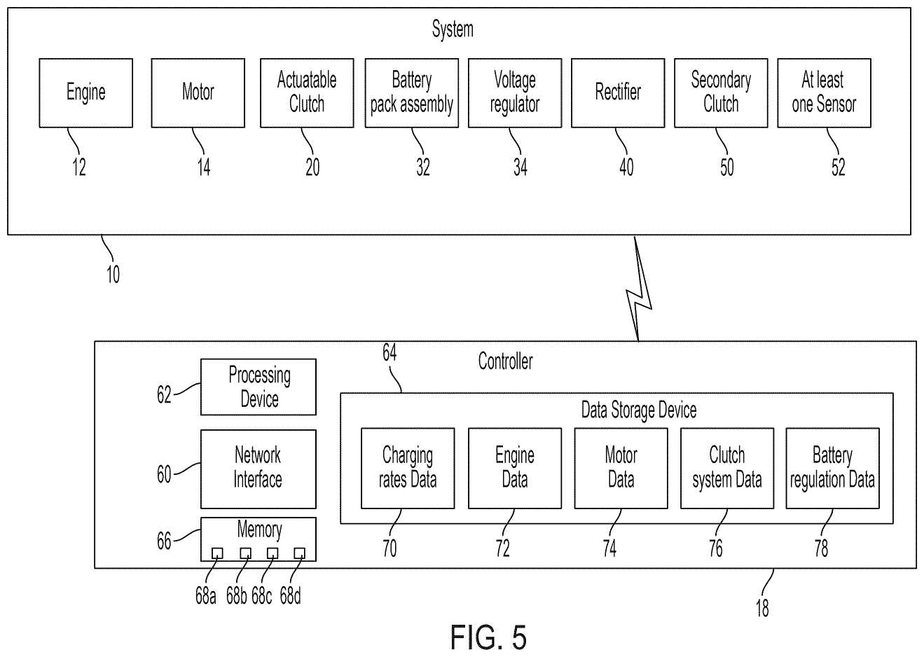

The controller 18 is configured to provide the operations for the engine 12 and the motor 15 when in the generator/alternator mode 30, and facilitates each of engine start-up, shutdown, data measurement, data display and fault protection functions, additional to generator power measurement, power display and power protection. The controller 18 is provided to be communicatively coupled with the voltage regulator 34 via, in some embodiments, the communication line 44, and to the battery pack assembly 32 via, in some embodiments, a communication line 46. This is non-limiting and the communication may be wireless. The controller 18 may be an electronic control unit (ECU), a central processing unit (CPU), and the like, to include the necessary components to function as electronic control unit (ECU), a central processing unit (CPU), and the like as well as a genset controller and a charging controller, as discussed in greater detail herein with respect to FIG. 5.

Data may transfer between the battery pack assembly 32 and the controller 18 in a bi-directional manner such as data related a current charge of the battery pack assembly 32, an overall power requirement of the battery pack assembly 32, a temperature of the battery pack assembly 32, and other data that may be sensed or saved, as discussed in greater detail herein. In response, the controller 18 may provide commands or instructions to other components of the system 10 to vary or change speeds of the engine 12, the motor 15, the compressor 16, and/or any other component of the system 10 during charging of the battery pack assembly 32 based on the plurality of battery related data to vary the direct current voltage output to the battery pack assembly 32, as discussed in greater detail herein. Varying such operating speeds during charging optimizes a charging efficiency based determined overall power requirements and with specific engine efficiency map of the system 10. As such, specific voltage adjustments may be made based on the data from requirements and performed by the controller 18 and the rectifier component 40. That is, the controller 18 is configured to automatically or autonomously regulate a charging output of using the voltage regulator 34 and the rectifier component 40 to regulate the charging output, such as, without limitation, a direct-current output, to adjustable charge the battery pack assembly 32. For example, the controller 18 may adjust at least one of a charging voltage or a charging current in response to battery telemetry data including a state of charge and a temperature of the battery pack assembly 32.

As such, when in the generator/alternator mode 30, the speed (RPM) of the motor 15 may be automatically or autonomously adjusted by the controller 18 over the course of the charging cycle, which is further in real time communication with the battery pack assembly 32, such as to adjust (typically lower) the speed of the motor 15 in response to look up table variables associated with optimal charging rates of the battery pack assembly, as determined by the controller 18, and taking into account such factors as the battery temperature and current charge level and in order to achieve an efficiency sweet spot, as discussed in greater detail herein.

Now referring to FIG. 4, the system 10′ depicted in FIG. 4 is identical to the system 10 depicted in FIGS. 1-2, with the exception that, in some embodiments, the clutch system 49 includes the actuatable clutch 20 and the secondary clutch 50, or additional clutch, between the motor 15 and the compressor 16. As such, the secondary clutch 50 is positioned to separate the motor 15 from the compressor 16. When the cooling/refrigeration is at a desired temperature, the engine 12 may be configured to run only the motor 15 in the generator/alternator mode 30 without also engaging the compressor 16. To achieve the engine 12 running only the motor 15 in the generator/alternator mode 30 without also engaging the compressor 16, the second clutch 50 is configured to selectively permit the engine 12 to drive the motor 15 or the compressor 16 or both depending on whether the demand for the system 10′ is power generating or cooling modes. In the embodiment depicted in FIG. 4, the engine 12 is driving the motor shaft 14, therefore the actuatable clutch 20 permits for rotation of the motor shaft 14 and the motor 15 in activating in the generator/alternator mode 30, as discussed with respect to FIG. 3.

Further, the secondary clutch 50 may be configured to be selectively engaged or not engaged to not permit or allow any power transmission from the engine 12 to the compressor 16. Therefore, because there is not a need for cooling, the engine 12 and the motor 15 may be operational without the need for the compressor to also be operational. As such, the engine 12 and the motor 15 may be in the generator/alternator mode 30 to generate electric power even when no refrigeration is needed and can continue to charge the battery pack assembly 32 (FIG. 3), as discussed in greater detail herein with respect to FIG. 3.

As such, the system 10 is configured as a chilling system with internal backup system as well as a power generator in providing a high efficiency chilling unit.

The system 10 is also configured to solve an additional problem in a data centers, where chilling needs are based on the processing load of a GPU or a rack, requiring a separate condenser to be assigned to each rack with a heat exchanger and a separate thermostat. In conventional systems, the temperature is maintained to the desired target based on the rack itself and not as an entire system. As such, the arrangement of the system 10 described herein prevents an overcooling of another rack unnecessarily.

As such, combining the components of the system 10 with the engine 12 described above, results in less of an environmental impact, a higher efficiency and renewable fuels that can substantially impact the carbon footprint of a facility.

Now referring to FIG. 5, the controller 18 includes a network interface 60, a processing device 62, a data storage device 64, and memory component 66. The processing device 62, such as the electronic control unit or computer processing unit, may be the central processing unit of the controller 18, performing calculations and logic operations to execute a program. The processing device 62, alone or in conjunction with the other components, is an illustrative processing device, computing device, processor, or combination thereof. The processing device 62 may include any processing component configured to receive and execute instructions (such as from the memory component 66).

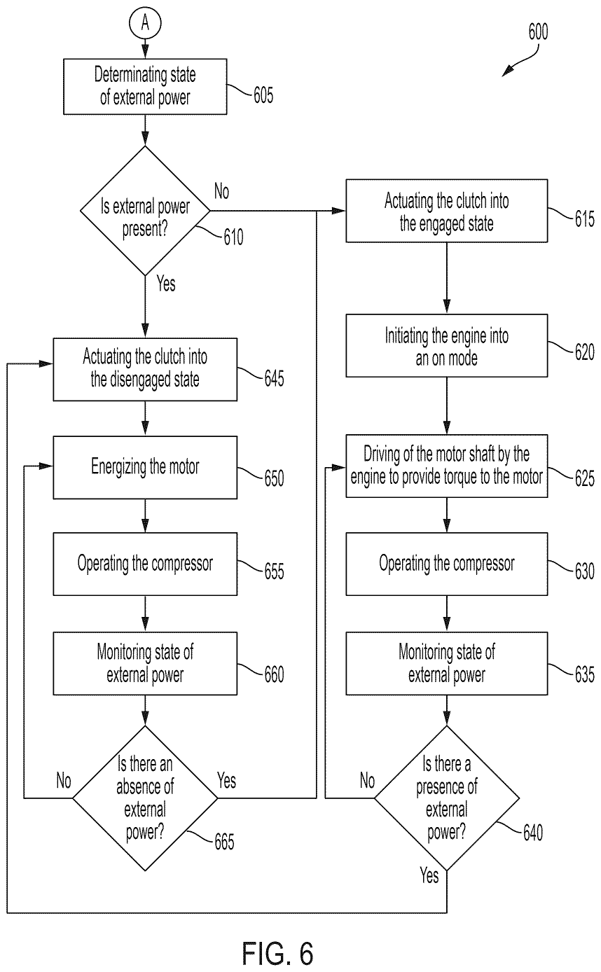

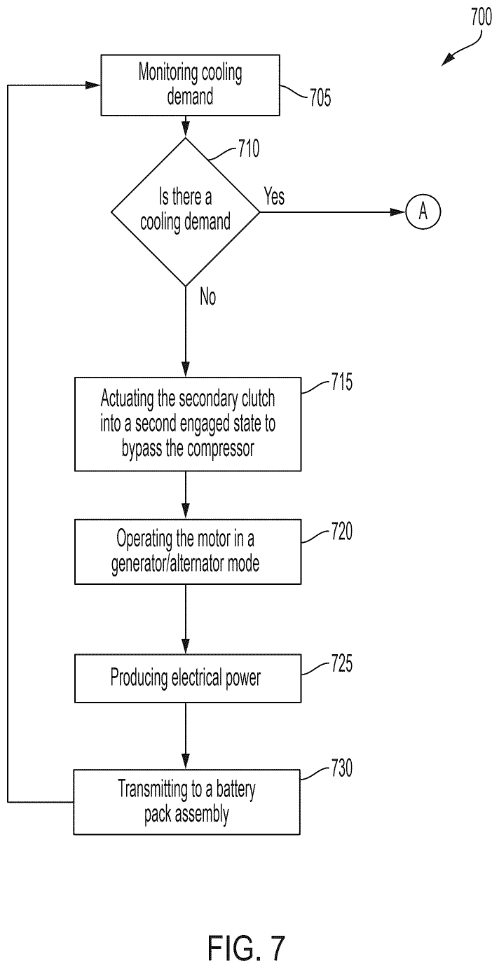

In some embodiments, the memory component 66 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. Further, the memory component 66 may be a non-transitory, processor-readable memory. The memory component 66 may include one or more programming instructions thereon that, when executed by the processing device 62, cause the processing device 62 to complete various processes, such as one or more of the processes described herein with respect to FIGS. 6-7.

Still referring to FIG. 5, the programming instructions stored on the memory component 66 may be embodied as one or more software logic modules, where each logic module provides programming instructions for completing one or more tasks, as described in greater detail below with respect to FIG. 6. For instance, an operating module 68a may include a plurality of different pieces of logic, each of which may be embodied as a computer program, firmware, and/or software/hardware, which may be executable by the processing device 62 to include an operating system and/or other software for managing components of the controller 18 and the system 10 (FIG. 1).

An engine-powered mode logic module 68b may include a plurality of different pieces of logic, each of which may be embodied as a computer program, firmware, and/or software/hardware, which may be executable by the processing device 62 to determine an absence or presence of external power such as the external electricity 28, and in response to a determination of the absence of external electricity 28, initiate the engine-on mode to control the engine 12 to power the compressor 16, through the engagement of the actuatable clutch 20 and the motor 15. Further, the engine-powered mode logic module 68b may be configured to monitor and control the engine 12 as needed to optimize or maximize performance, as discussed in greater detail herein.

A grid-powered mode logic module 68c may include a plurality of different pieces of logic, each of which may be embodied as a computer program, firmware, and/or software/hardware, which may be executable by the processing device 62 to determine an absence or presence of external power such as the external electricity 28, and in response to a determination of the presence of external electricity 28, initiate an engine off mode where the engine 12 is inhibited from operation.

A generator/alternator mode logic module 68d may include a plurality of different pieces of logic, each of which may be embodied as a computer program, firmware, and/or software/hardware, which may be executable by the processing device 62 to determine whether an generator/alternator mode is required and to facilitate the generator/alternator mode by controlling the engine 12 to power the motor 15, through the engagement of the actuatable clutch 20 and the secondary clutch 50. Further, the generator/alternator mode logic module 68d may be configured to monitor and control the engine 12 as needed to optimize or maximize performance, as discussed in greater detail herein.

The network interface 60 of the controller 18 may include any wired or wireless networking hardware, such as a modem, LAN port, wireless fidelity (Wi-Fi) card, WiMax card, mobile communications hardware, and/or other hardware for communicating with other networks and/or devices and/or provide signals and communication through data exchange, signals, commands, and/or the like, such as, without limitation, through the wires 44, 46. Therefore, the communication between the controller and the other components of the system 10 may be provided through the network interface 60. In one example, the controller 18 may wirelessly communicate with the engine 12 and/or the actuatable clutch 20.

The data storage device 64, which may generally be a storage medium, may contain one or more data repositories for storing data that is received and/or generated, and may be any physical storage medium, including, but not limited to, a hard disk drive (HDD), memory, removable storage, and/or the like. While the data storage device 64 is depicted as a local device, it should be understood that the data storage device 64 may be a remote storage device, such as, for example, a server computing device or the like. Illustrative data that may be contained within the data storage device 64 is described below with respect to FIG. 7 and includes, but is not limited to, a charging rates data 70, an engine data 72, a motor data 74, a clutch system data 76, and a battery regulation data 78.

The charging rates data 70 may include data such as look up tables or the like that are used to maximize or optimize the charging of the battery pack assembly 32. The engine data 72 may include data related to specific engine efficiency map such as data related to where the specific engine converts fuel into mechanical work across its entire operating range and may identify “sweet spots” where the engine consumes the least amount of fuel, such as, without limitation, for every kilowatt of power it produces, optimal ranges, set points, and the like. Further, the engine data 72 may include data related to the type of engine, fuel type and consumption behavior, whether the engine 12 is in the powered on mode or powered off mode. Further, the engine data 72 may include data regarding the presence or absence of external electricity 28 (FIG. 1) in real time, the current HVAC demand of the system 10, the demand for operation and coordination of associated HVAC components, such as, without limitation, condensers 22, an indoor blower fan 24, and an outdoor condenser fan 26.

The motor data 74 may include data related to the type of the motor 15, specs and ranges of the motor 15, whether the motor 15 is in the generator/alternator mode 30 to produce electrical power for system auxiliaries and/or facility loads and/or to harvest the surplus shaft power, if any, or in the conventional drive mode for the compressor when the external electricity 28 is present. The clutch system data 76 may include data as to the type and operation of the actuatable clutch 20 and the secondary clutch 50, whether either of the actuatable clutch 20 and/or the secondary clutch 50 are in the engaged state or disengaged state, respectively, and the like.

The battery regulation data 78 may be data related to the overall power requirement of the battery pack assembly 32, the temperature of the battery pack assembly 32, and other data that may be sensed or saved, commands to vary or change speeds of the engine 12, the motor 15, the compressor 16, and/or any other component of the system 10 during charging of the battery pack assembly 32 to optimize charging efficiency based determined overall power requirements and with specific engine efficiency map.

Still referring to FIGS. 1 and 5, the controller 18 may use data stored on the data storage device 64 to coordinate, based on the presence or absence of external electricity, energizing motor 15 to drive the compressor 16 while engine 12 remains off (e.g., in the grid-powered mode), engaging the actuatable clutch 20, starting the engine 12, and commanding a target RPM to satisfy a cooling setpoint (e.g., in the engine-powered mode), selectively operating the motor 15 to supply regulated DC through the voltage regulator 34 and the rectifier component 40 to battery pack assembly 32 (e.g., in the generator/alternator mode 30), optionally decoupling the compressor 16 via the secondary clutch 50 to prioritize power generation and/or restoring grid-drive and shutting down the engine 12 upon grid return and satisfaction of thermal and charging criteria.

As such, the controller 18 is configured to target each of the parameters of an engine speed, a load and a flow of gas based on individual repowering target to reach higher overall efficiency based on a formula that will be customized to each system needs and environments. Further, the controller 18 may be configured to determine whether to initiate commands to start the engine 12 based on whether the external electricity 28 is active or inactive.

It should be understood that while some of the components of FIG. 5 are illustrated as residing within the controller 18 while others reside within the system 10, this is merely an example thereof. In some embodiments, one or more of the components may reside solely within the controller 18, or, in the alternative, one or more components may be remote to the system 10 and/or the controller 18.

Referring now to FIG. 6, which depicts an example method 600 for switching between the grid-powered mode and the engine-powered mode. Although the steps associated with the blocks of FIG. 6 will be described as being separate tasks, in other embodiments, the blocks may be combined or omitted. Further, while the steps associated with the blocks of FIG. 6 will be described as being performed in a particular order, in other embodiments, the steps may be performed in a different order.

At block 605, there is a determination on the state of external power. The determination may be by the controller 18. In other embodiments, the determination may be an input initiated by a user. At block 610, there is a decision based on the state of the power as to whether the external power is present (e.g., active). When the decision in block 610 is that there is the presence of the external electricity 28, then the grid-power mode is activated by, at block 645, actuating the actuatable clutch 20 into the disengaged state (or confirming that the actuatable clutch 20 is in the disengaged state), using the external electricity 28 to energize the motor 15, at block 650, which in turn operates the compressor 16, at block 655. It should be appreciated that the engaging and disengaging of the actuatable clutch 20 and the energizing of the motor 15 may be automatically or autonomously performed by the controller 18.

The state of the power is continuously monitored, at block 660 and, at block 665, there is a determination whether there is a change in power conditions i.e., an absence of the external electricity 28. It should be understood that when there is not a change in power conditions (i.e., when the external electricity 28 remains present (e.g., not absent), then blocks 645 to block 665 may continuously loop) when there is a demand for cooling (e.g., operating the compressor 16).

When the determination at block 665 is that there is a change in the state of the external power to now there is not external electricity 28 supplied to the system 10 (e.g., an absence of external electricity 28), or when, at block 610, that the decision is that there is not external electricity 28 supplied to the system 10 (e.g., an absence of external electricity 28), then the engine-power mode is activated by, actuating the actuatable clutch 20 into the engaged state (or confirming that the actuatable clutch 20 is in the engaged state), at block 615, initiating the engine 12 into the on mode, at block 620, which causes the driving of the motor shaft 14 by the torque output from the engine 12 to provide mechanical torque to the motor 15, at block 625, which then operates the compressor, at block 630. It should be appreciated that the engaging and disengaging of the actuatable clutch 20, the activation of the engine 12 into the on mode, and the output of torque into the motor shaft 14 to mechanical drive the motor 15 may be automatically or autonomously performed by the controller 18

The state of the power is continuously monitored, at block 635 and, at block 640, there is a determination whether there is a change in power conditions i.e., an presence of the external electricity 28. It should be understood that when there is not a change in power conditions (i.e., a presence of the external electricity 28), then blocks 615 to block 640 may continuously loop) when there is a demand for cooling (e.g., operating the compressor 16). When, at block 640, it is determined that there is the presence of the external electricity 28, then the grid-power mode is activated by, at block 645, actuating the actuatable clutch 20 into the disengaged state (or confirming that the actuatable clutch 20 is in the disengaged state), using the external electricity 28 to energize the motor 15, at block 650, which in turn operates the compressor 16, at block 655.

Referring now to FIG. 7, which depicts an example method 700 for switching to the generator/alternator mode. Although the steps associated with the blocks of FIG. 7 will be described as being separate tasks, in other embodiments, the blocks may be combined or omitted. Further, while the steps associated with the blocks of FIG. 7 will be described as being performed in a particular order, in other embodiments, the steps may be performed in a different order.

At block 705, the system 10 may monitor for a cooling demand. These may be automatic by the controller 18 or may be user initiated. At block 710, when there is a cooling demand, the method 700 determines the state of the external power, at block 605 in the example method 600, described above with respect to FIG. 6, and continues to follow the example method 600 described above with respect to FIG. 6. When there is a determination that there is not a cooling demand, at block 710, the secondary clutch 50 of the clutch system 49 may be actuated into a second engaged state to bypass the compressor, at block 715. At block 720, the motor 15 is operated in the generator/alternator mode to produce electrical power, at block 725, which is transmitted or output to the battery pack assembly, at block 730. In the generator/alternator mode, the motor 15 may use prestored data and sensed data to maximize or optimize the charging of the battery pack assembly 32.

It should be understood that the example method 600 and the example method 700 may be intertwined with one another, may be performed discreetly from one another and/or may be performed simultaneously with one another. As such, the example method 700 may be performed in the presence of power (e.g., using the external electricity 28 to drive the motor 15, or in the absence of power where the engine 12 is mechanically driving the motor 15).

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### Aspects Listing

Aspect 1. A hybrid power generating and chilling/refrigeration system includes an engine, a motor having a motor shaft, a compressor mechanically coupled to the motor, a clutch configured to be actuatable between a disengaged state and an engaged state to selectively couple torque from the engine to the motor shaft, a processing device communicatively coupled to the engine, the motor, and the clutch, and a non-transitory, processor-readable storage medium in communication with the processing device. The non-transitory, processor-readable storage medium comprising one or more programming instructions that, when executed, cause the processing device to: receive an input regarding a presence or an absence of an external electricity; when in the presence of the external electricity, initiate a grid-powered mode configured to actuate the clutch into the disengaged state and drive the compressor using the external electricity to power the motor, and when in the absence of the external electricity, initiate an engine-driven mode configured to start the engine, actuate the clutch into the engage stated, and drive the compressor via a mechanical torque output from the engine onto the motor shaft. The system is configured to selectively alternate between the grid-powered mode and the engine-driven mode without converting engine shaft power to grid-frequency electricity to operate the compressor.

Aspect 2. The system of Aspect 1, wherein the processing device commands an operating speed of at least one of the engine and the motor based on a cooling setpoint and an efficiency map to operate the compressor within an predetermined efficiency band.

Aspect 3. The system of any of Aspect 1 to Aspect 2, wherein the motor is further configured to operate in a generator/alternator mode to generate a second electrical power.

Aspect 4. The system of any of Aspect 2 to Aspect 3, further including a voltage regulator and a rectifier component configured to provide a regulated direct-current output to a battery pack assembly.

Aspect 5. The system of any Aspect 1 to Aspect 4, wherein the processing device is communicatively coupled to the battery pack assembly to adjust at least one of a charging voltage or a charging current in response to battery telemetry including state of charge and temperature.

Aspect 6. The system of Aspect 1 to Aspect 5, further including a second clutch disposed between the motor and the compressor and actuatable between a second engaged state and a second disengaged state.

Aspect 7. The system of Aspect 1 to Aspect 6, wherein the non-transitory, processor-readable storage medium comprising one or more programming instructions that, when executed, cause the processing device to: actuate the second clutch into the disengaged state to permit the engine to drive the motor in the generator/alternator mode without driving the compressor.

Aspect 8. The system of Aspect 1 to Aspect 7, wherein the positioning of the second clutch permits the engine to drive the motor in the generator/alternator mode while the compressor is decoupled from the motor.

Aspect 9. The system of any of Aspect 1 to Aspect 8, wherein the non-transitory, processor-readable storage medium comprising one or more programming instructions that, when executed, cause the processing device to: adjust an operating speed of the engine to correspond to an efficiency range of the engine.

Aspect 10. The system of any of Aspect 1 to Aspect 9, wherein the non-transitory, processor-readable storage medium comprising one or more programming instructions that, when executed, cause the processing device to: monitor for the presence or the absence of external electricity, and in response to the monitoring, automatically initiate the grid-powered mode or the engine-driven mode based on the presence or the absence of external electricity.

Aspect 11. The system of any of Aspect 1 to Aspect 10, wherein the non-transitory, processor-readable storage medium comprising one or more programming instructions that, when executed, cause the processing device to: monitor a cooling demand, when the cooling demand is satisfied, operating the motor in a generator/alternator mode to produce electrical power, and regulate a charging output using a voltage regulator and a rectifier component to charge a battery pack assembly.

Aspect 12. The system of any of Aspect 1 to Aspect 11, wherein the non-transitory, processor-readable storage medium comprising one or more programming instructions that, when executed, cause the processing device to: adjust at least one of engine speed of the engine or generator speed of the motor to an efficiency operating point based on a battery temperature, a charging current, and a state of charge of the battery pack assembly.

Aspect 13. The system of any of Aspects 1-12.

Aspect 14. A method for operating a hybrid power generating and chilling/refrigeration system including monitoring an availability of an external electricity, when the external electricity is present, actuating a clutch into a disengaged state, and energizing a motor via the external electricity to drive a compressor, and upon loss of the external electricity, actuating the clutch into an engaged state and initiating the engine into an on mode to output a torque, and driving the compressor via the motor through a motor shaft.

Aspect 15. The method of Aspect 14, further including: monitoring a cooling demand, when the cooling demand is satisfied, operating the motor in a generator/alternator mode to generate electrical power, and regulating a charging output using a voltage regulator and a rectifier component to charge a battery pack assembly.

Aspect 16. The method of Aspect 14 or Aspect 15, wherein in the generator/alternator mode, actuating a second clutch into a second disengaged state, the second clutch positioned between the motor and the compressor to continue electrical power generation by the motor without driving the compressor.

Aspect 17. The method any of Aspect 14 to Aspect 16, further including adjusting at least one of engine speed of the engine or generator speed of the motor to an efficiency operating point based on a battery temperature, a charging current, and a state of charge of the battery pack assembly.

Aspect 18. The method of Aspect 14, further including implementation of any combination of features of Aspects 1-12.

Aspect 19. A hybrid power generating and chilling/refrigeration system including an internal combustion engine, a motor having a motor shaft, a compressor mechanically coupled to the motor, and a clutch configured to be actuatable between a disengaged state and an engaged state to selectively couple torque from the engine to the motor shaft, the system further including: a processing device communicatively coupled to the engine, the motor, and the clutch; and a non-transitory, processor-readable storage medium in communication with the processing device. The non-transitory, processor-readable storage medium comprising one or more programming instructions that, when executed, cause the processing device to: receive an input regarding a presence or an absence of an external electricity, when in the presence of the external electricity, initiate a grid-powered mode configured to actuate the clutch into the disengaged state and drive the compressor using the external electricity to power the motor, when in the absence of the external electricity, initiate an engine-driven mode configured to start the internal combustion engine, actuate the clutch into the engaged state, and drive the compressor via a mechanical torque output from the internal combustion engine onto the motor shaft, and adjust an operating speed of the engine to correspond to an efficiency range of the engine prestored in the processor-readable storage medium. The system is configured to selectively alternate between the grid-powered mode and the engine-driven mode without converting engine shaft power to grid-frequency electricity to operate the compressor, and the motor is configured to operate powered from the external electricity and mechanically through the engine and the motor shaft, and is configured to operate in a generator/alternator mode to generate a second electrical power.

Aspect 20. The system of Aspect 19, further including a voltage regulator and a rectifier component configured to provide a regulated direct-current output to a battery pack assembly, and a second clutch disposed between the motor and the compressor and actuatable between a second engaged state and a second disengaged state.

Aspect 21. The system of any of Aspect 19 to Aspect 20, wherein the processing device is communicatively coupled to the battery pack assembly to adjust at least one of a charging voltage or a charging current in response to battery telemetry including state of charge and temperature, and the non-transitory, processor-readable storage medium comprising one or more programming instructions that, when executed, cause the processing device to: actuate the second clutch into the disengaged state to permit the engine to drive the motor in the generator/alternator mode without driving the compressor.

Aspect 22. The system of any of Aspect 19 to Aspect 21, wherein the non-transitory, processor-readable storage medium comprising one or more programming instructions that, when executed, cause the processing device to: monitor for the presence or the absence of external electricity, and in response to the monitoring, automatically initiate the grid-powered mode or the engine-driven mode based on the presence or the absence of external electricity.

Aspect 23. The system of any of Aspects 19-22 further including implementation of any combination of features of Aspects 1-12 and/or the method of any of Aspects 14-18.

1. A hybrid power generating and chilling/refrigeration system comprising:
an engine;
a motor having a motor shaft;
a compressor mechanically coupled to the motor;
a clutch configured to be actuatable between a disengaged state and an engaged state to selectively couple torque from the engine to the motor shaft;
a processing device communicatively coupled to the engine, the motor, and the clutch; and
a non-transitory, processor-readable storage medium in communication with the processing device, wherein the non-transitory, processor-readable storage medium comprising one or more programming instructions that, when executed, cause the processing device to:
receive an input regarding a presence or an absence of an external electricity;
when in the presence of the external electricity, initiate a grid-powered mode configured to actuate the clutch into the disengaged state and drive the compressor using the external electricity to power the motor; and
when in the absence of the external electricity, initiate an engine-driven mode configured to start the engine, actuate the clutch into the engage stated, and drive the compressor via a mechanical torque output from the engine onto the motor shaft,
wherein the system is configured to selectively alternate between the grid-powered mode and the engine-driven mode without converting engine shaft power to grid-frequency electricity to operate the compressor.

2. The system of claim 1, wherein the processing device commands an operating speed of at least one of the engine and the motor based on a cooling setpoint and an efficiency map to operate the compressor within an predetermined efficiency band.

3. The system of claim 1, wherein the motor is further configured to operate in a generator/alternator mode to generate a second electrical power.

4. The system of claim 3, further comprising:
a voltage regulator and a rectifier component configured to provide a regulated direct-current output to a battery pack assembly.

5. The system of claim 4, wherein the processing device is communicatively coupled to the battery pack assembly to adjust at least one of a charging voltage or a charging current in response to battery telemetry including state of charge and temperature.

6. The system of claim 3, further comprising:
a second clutch disposed between the motor and the compressor and actuatable between a second engaged state and a second disengaged state.

7. The system of claim 6, wherein the non-transitory, processor-readable storage medium comprising one or more programming instructions that, when executed, cause the processing device to:
actuate the second clutch into the disengaged state to permit the engine to drive the motor in the generator/alternator mode without driving the compressor.

8. The system of claim 6, wherein the positioning of the second clutch permits the engine to drive the motor in the generator/alternator mode while the compressor is decoupled from the motor.

9. The system of claim 1, wherein the non-transitory, processor-readable storage medium comprising one or more programming instructions that, when executed, cause the processing device to:
adjust an operating speed of the engine to correspond to an efficiency range of the engine.

10. The system of claim 1, wherein the non-transitory, processor-readable storage medium comprising one or more programming instructions that, when executed, cause the processing device to:
monitor for the presence or the absence of external electricity; and
in response to the monitoring, automatically initiate the grid-powered mode or the engine-driven mode based on the presence or the absence of external electricity.

11. The system of claim 10, wherein the non-transitory, processor-readable storage medium comprising one or more programming instructions that, when executed, cause the processing device to:
monitor a cooling demand;
when the cooling demand is satisfied, operating the motor in a generator/alternator mode to produce electrical power; and
regulate a charging output using a voltage regulator and a rectifier component to charge a battery pack assembly.

12. The system of claim 11, wherein the non-transitory, processor-readable storage medium comprising one or more programming instructions that, when executed, cause the processing device to:
adjust at least one of engine speed of the engine or generator speed of the motor to an efficiency operating point based on a battery temperature, a charging current, and a state of charge of the battery pack assembly.

13. A method for operating a hybrid power generating and chilling/refrigeration system comprising:
monitoring an availability of an external electricity;
when the external electricity is present, actuating a clutch into a disengaged state, and energizing a motor via the external electricity to drive a compressor; and
upon loss of the external electricity, actuating the clutch into an engaged state and initiating the engine into an on mode to output a torque, and driving the compressor via the motor through a motor shaft.

14. The method of claim 13, further comprising:
monitoring a cooling demand;
when the cooling demand is satisfied, operating the motor in a generator/alternator mode to generate electrical power; and
regulating a charging output using a voltage regulator and a rectifier component to charge a battery pack assembly.

15. The method of claim 14, wherein in the generator/alternator mode, actuating a second clutch into a second disengaged state, the second clutch positioned between the motor and the compressor to continue electrical power generation by the motor without driving the compressor.

16. The method of claim 14, further comprising:
adjusting at least one of engine speed of the engine or generator speed of the motor to an efficiency operating point based on a battery temperature, a charging current, and a state of charge of the battery pack assembly.

17. A hybrid power generating and chilling/refrigeration system including an internal combustion engine, a motor having a motor shaft, a compressor mechanically coupled to the motor, and a clutch configured to be actuatable between a disengaged state and an engaged state to selectively couple torque from the engine to the motor shaft, the system comprising:
a processing device communicatively coupled to the engine, the motor, and the clutch; and
a non-transitory, processor-readable storage medium in communication with the processing device, wherein the non-transitory, processor-readable storage medium comprising one or more programming instructions that, when executed, cause the processing device to:
receive an input regarding a presence or an absence of an external electricity,
when in the presence of the external electricity, initiate a grid-powered mode configured to actuate the clutch into the disengaged state and drive the compressor using the external electricity to power the motor;
when in the absence of the external electricity, initiate an engine-driven mode configured to start the internal combustion engine, actuate the clutch into the engaged state, and drive the compressor via a mechanical torque output from the internal combustion engine onto the motor shaft; and
adjust an operating speed of the engine to correspond to an efficiency range of the engine prestored in the processor-readable storage medium,
wherein the system is configured to selectively alternate between the grid-powered mode and the engine-driven mode without converting engine shaft power to grid-frequency electricity to operate the compressor, and
wherein the motor is configured to operate powered from the external electricity and mechanically through the engine and the motor shaft, and is configured to operate in a generator/alternator mode to generate a second electrical power.

18. The system of claim 17, further comprising:
a voltage regulator and a rectifier component configured to provide a regulated direct-current output to a battery pack assembly; and
a second clutch disposed between the motor and the compressor and actuatable between a second engaged state and a second disengaged state.

19. The system of claim 18, wherein the processing device is communicatively coupled to the battery pack assembly to adjust at least one of a charging voltage or a charging current in response to battery telemetry including state of charge and temperature, and the non-transitory, processor-readable storage medium comprising one or more programming instructions that, when executed, cause the processing device to:
actuate the second clutch into the disengaged state to permit the engine to drive the motor in the generator/alternator mode without driving the compressor.

20. The system of claim 17, wherein the non-transitory, processor-readable storage medium comprising one or more programming instructions that, when executed, cause the processing device to:
monitor for the presence or the absence of external electricity,
in response to the monitoring, automatically initiate the grid-powered mode or the engine-driven mode based on the presence or the absence of external electricity.
